(19) United States
(12) Patent Application Publication
(10) Pub. No.: US 2007/0168125 A1
(43) Pub. Date: Jul. 19, 2007

(54) GPS MONITORING BIOMETRIC SMARTCARD, INTELLIGENT SPEED MANAGMENT

(76) Inventor: Stephen Petrik, Capalaba, Queensland (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/572,130

(22) PCT Filed: Aug. 9, 2005
(86) PCT No.: PCT/AU05/01187

§ 371 Date: Jan. 15, 2007

(30) Foreign Application Priority Data
Aug. 12, 2004 (AU) 2004203830

(51) Int. Cl. B60T 8/32; G01C 21/00

(52) U.S. Cl. 701/213; 701/200; 701/93

(57) ABSTRACT

A method and system which, provides real time GPS based vehicle monitoring, management and cruise control by a small, single, sealed, the in-vehicle monitoring unit, incorporating intelligent speed adaptation, recording driver and vehicle operating parameters in memory and on a smart card a SATELITE/GPRS/GSM/BLUETOOTH mobile communication facility under the control of a national Transport Management Command Centre.

This invention relates to a method and system, which, provides GPS based vehicle monitoring, management and cruise control, incorporating intelligent speed adaptation, recording driver and vehicle operating parameters on a smart card and a SATELITE/GPRS/GS/MBLUETOOTH mobile communication facility by an in vehicle small, single sealed monitoring unit.

The method and system is coordinated through and by a national Transport Management Command Centre operating 24 hours per day 365 days per year.

Transport Authorities in every state/country are responsible for regulating the transport industry with regards to operational parameters such as licensing, vehicle registration, vehicle safety, fuel subsidies, freight rates and drivers' working and rest hours. The burden of ever the increasing competition between trucks and private vehicles for space on overcrowded roads is also a universal issue.

Simultaneously police in every jurisdiction are charged with enforcing traffic laws, road safety and speed regulations for all types of vehicles whilst trying to promote responsible driving habits such as regular rest periods for commercial and private vehicle drivers to combat fatigue related accidents.

Additionally, since the Sep. 11, 2001 attack on the New York World Trade Centre and subsequent world wide uses of vehicles as mobile bombs, security issues related to transport cargo are also of paramount interest.

Whereas different methods and systems to control the transport industry exist, they are all inefficient and subject to manipulation. Specifically the recording and control of legislated drivers' work and rest hours via log books are open to fraud. The present reliance on paper records is futile and the use of tachographs is regularly compromised by illegal manipulation of sensors and disconnection of installed speed governors. A centrally available advanced knowledge data base of road use, truck movements or dangerous cargos carried does not exist in any state or country.

The police have the difficulty of trying to cover huge road networks with ever increasing traffic loads and lack of sufficient manpower in their attempts to enforce road safety and speeding regulations.

While recently passed laws in Australia hold every person in the transport industry chain including owner, operator, driver and customer responsible for any offences, competitive pressures induce many to break the law and endanger the public. This is a world wide phenomenon. A system that cannot be compromised is required.

These problems are overcome by the present invention, which provides a method and system of automatically and irrefutably logging via GPS, operational parameters such as drivers' work and rest time, vehicle location, vehicle speeds, speeding offences, distance covered etc. and recording these on a secure smart card as well as in the vehicle units’ memory.

A national Transport Management Command Centre with an up to date data base of road conditions is established. The SATELITE/GPRS/GSM/BLUETOOTH provides a real time communication link with the Command Centre and the vehicles. It also automatically informs the Command Centre in case of accidents when the GPS reports an impact or sudden stop.

Intended vehicle route plans and cargo details are automatically “filed” in the unit and with the national Transport Management Command Centre via the SATELITE/GPRS/GSM/BLUETOOTH prior to the start of each journey. Police workload is reduced since speed regulations are enforced in real time by the system and violators are automatically reported.

GPS is inherently and irrefutably the most accurate technology providing date, time, location and speed. Operating independent of vehicle sensor inputs it cannot be affected by fraudulent manipulation of vehicle functions. Unlike tachographs, it never needs calibration.

Smart cards supported by indisputable biometric fingerprints are the most secure forms of information storage available.

SATELITE/GPRS/GSM/BLUETOOTH is the cheapest and most convenient communication platform for mobile communications in logistic applications.

Transport vehicles and trailers come in many configurations, shapes, and sizes. To ensure easy installation on commercial as well as private vehicles, and trailers, this invention is provided in four forms all being a small, single, sealed monitoring/communication unit.

### FORM ONE OF THE INVENTION

In form one of the invention, the in vehicle monitoring unit consists of 16 components namely, a custom designed micro computer, a GPS receiver module, a smart card reader/writer, a SATELITE/GPRS/GSM/BLUETOOTH module, a fingerprint verification module, a display, a beeper, a USB connector, a backup battery pack, an accelerometer, a power connector, a communications button, a sleep button, a load/unload button, an engine management system connector and a battery charger integrated into a small, single, sealed unit.

Secure smart cards supported by biometric fingerprints are used as the drivers' log books.

The monitoring unit is supplied with an upgradeable software program which, enables and disables engine ignition on the insertion and the removal of a valid driver card; provides a SATELITE/GPRS/GSM remote central and a BLUETOOTH local engine disable function; provides GPS based cruise control and an automatic speed limiter function; stores previous 2 minutes of data logged by engine management system; controls every function of the unit; correlates each vehicle and driver related operational parameter and records the results in its’ memory as well as on the smart card.

The program also contains a table of state borders and a table of the geographical location of every speed zone change as per the 40Km/ph, 45Km/h, 50Km/h, 55Km/h, 60Km/h, etc. road speed signs throughout the country, and provides intelligent speed adaptation. Further, the program warns the driver each time he is due to take his mandatory break.

At the time of installation on the vehicle the unit is connected to the engine management system which is programmed to take instructions from it. The unit is turned on and from that moment it is never turned off again (though it may go into sleep mode) regardless of wether the vehicle is operating or not. Turning off or disconnecting the unit from the engine management system disables engine ignition. This ensures 24 hour a day 365 day per year monitoring of vehicle activity. If the monitoring unit is ever turned off or disconnected for any reason the date time and place is automatically logged in its memory allowing actionable discovery by relevant authorities.

Every unit has securely encoded in its' memory the registration number of the vehicle to which it is issued and on which it is installed. This prevents fraudulent or unauthorised swapping of units between vehicles.

Drivers are issued with their logbook smart cards with their fingerprint template recorded in the card.

Method of Operation

Prior to each departure, dispatch automatically “files” the intended vehicle rout plan and cargo details with the national Transport Management Command Centre and in the in-vehicle unit via the SATELITE/GPRS/GSM. The Transport Management Command Centre checks its up to date national data base to see if any obstacles such as accidents, road closures, detours, adverse weather etc. exist along the intended route and notifies the dispatcher and the vehicle via the SATELITE/GPRS/GSM of same.

At the start of the journey the driver inserts his smart card into the units’ smart card reader/writer and places his finger on the fingerprint reader to confirm his identity. This automatically logs him in as the current driver and enables engine ignition. Simultaneously the monitoring unit displays the “filed” truck rout plan and a time chart showing the required driver rest times calculated from the drivers' current work/rest status recorded on the smart card. The engine will not start if the monitoring unit is disconnected or an invalid driver card and fingerprint combination is presented. During the trip the GPS keeps a constant log of the date, time, location, distance travelled and speed of the vehicle both in the units' memory and in the smart card. The system provides convenient and fool proof automated intelligent speed adaptation for any and all vehicles. The GPS based cruise control is always active and can be programmed never to allow the vehicle to exceed a set absolute maximum speed. As the vehicle approaches each new speed zone, the unit using its' intelligent speed adaptation and geographically based speed zone location tables, beeps to warn the driver of the zone change and if allowed, interacts with the engine management system to slow down or speed up the vehicle to automatically stay within appropriate speed limits in each zone.

The driver can always override the system by using the break, or the accelerator to the set absolute maximum speed only, but regardless of the drivers' actions, wether speeding up or slowing down, the unit automatically records the date, time, location and current actual speed of the vehicle, only in case of speeding violations within each speed zone. This record proves beyond doubt what actual speed the vehicle was doing at a specific date, time and place and disproves any false charges of speeding.

This is important protection for any driver since universal experience has proven the consistent inaccuracy of radar and speed cameras used to incorrectly book motorists who claim the radar and cameras are just a revenue rasing exercise which does not help traffic issues.

The unit warns the driver every time he is due to take a rest break. When the driver stops for his break, he pushes the sleep button. The unit confirms his rest start by automatically logging the date, time and location when the vehicle stops moving. At the end of the rest period as the vehicle begins moving again the date, time and location is again logged automatically. The units' accelerometer eliminates any possibility of faking starts and stops. Throughout the journey the unit records the date, time, place and duration of each and every stop and start hence legally mandated rest times cannot be fudged.

At the start and end of each loading/unloading the driver pushes the load/unload button. The unit records the time and stationary position of the vehicle at the shipper/receiver location. This provides loading dock times for which shipper/receiver are charged and eliminates disputes.

The SATELITE/GPRS/GSM facility allows two way communications with the base station and the national Transport Management Command Centre both of which can give real time instructions to the driver. Using the “filed” proposed rout plan the national Transport Management Command Centre can help to manage safety and traffic flow by directing the driver to alter course in case traffic jams, accidents, road closures or adverse weather have developed after departure. If a driver diverts inappropriately from the “filed” route plan the unit notifies the Centre. A hostile driver or out of control vehicle can be stopped by sending a “disable” command to the unit via the SATELITE/GPRS/GSM to lock up the engine management unit.

In police chase situations a BLUETOOTH enabled hand held unit can be used locally within a limited radius to “disable” the engine management unit and stop the vehicle regardless of drivers' actions. BLUETOOTH has a maximum affective range of 100 meters and so will not affect other vehicles in the area. In chase situations the police on the scene are better able to judge at what point and in which situation the vehicle should be “disabled” to minimise potential runaway damage.

In case of accidents the accelerometer and the GPS notes the sudden change in speed and the unit automatically reports to the national Transport Management Command Centre with the date, time and place coordinates of the accident even if the driver is unconscious. The “filed” route plan and cargo details allow immediate dispatch of police and rescue crews pre-warned and appropriately prepared to handle any hazardous cargo. The Centre can guide other vehicles around the new problem area to reduce congestion. The last 2 minutes of data logged by the engine management system is also automatically sent to Central.

Roadside “Hours of Service” inspections are simplified and times are literally reduced to seconds. There is no need for complicated often conflicting paper based calculations since police and DOT can simply read at a glance the drivers' current work/rest status on the units’ display. Current infringements are displayed and can be acted on immediately. If a driver is “placed out of service” at roadside, police and DOT know at a glance at what future time he will accumulate enough off duty time to be back in compliance and be allowed to resume his duties.

State border crossings are automatically logged and/or reported via the SATELITE/GPRS/GSM.

At the end of the shift or trip the driver places his finger on the fingerprint reader. This logs him out and records his finishing time, date and place.

These records irrefutably prove his working and rest times and can also be used in accounting to automate his wage payments.

At the start of the next shift the new driver logs in as above and the monitoring process is repeated.

The vehicle units' records and the drivers' card serves as an audit trail.

Rental fleets such as Avis or Hertz and private vehicles can derive the same benefits from installation of the invention as commercial installations do but may only utilise some of the available functions. In private vehicles an owner/driver smart card license can be used to operate the system. On all installations the built in engine ignition disable feature replaces the need for expensive anti theft systems and should lower both vehicle and cargo insurance costs.

As the GPS records distance travelled, the possibility of vehicle odometer tampering is eliminated and used vehicle purchasers are fully protected.

### FORM TWO OF THE INVENTION

In form two of the invention the in-vehicle monitoring unit consists of 11 components namely a custom designed micro computer, a GPS receiver module, a display, a USB connector for software updates and record downloads, a backup battery pack, an accelerometer, a beeper, a display button, an engine management system connector a power/cigarette lighter connector and a battery charger integrated into a small, single, sealed unit. This form of the invention is more appropriate for voluntary use by conscientious drivers or mandatory use as part of vehicle registration to reduce reliance on police radar and speed cameras to enforce speed rules.

The monitoring unit is supplied with the upgradeable software program of form one of this invention which controls every function of the unit, correlates each vehicle and driver related operational parameter and records the results in its memory. The program also contains a table of the geographical location of every speed zone change as per the 40Km/ph, 45Km/h, 50Km/h, 55Km/h, 60Km/h, etc. road speed signs throughout the country and provides intelligent speed adaptation. Further the program warns the driver to take a suggested 10 minute safety break after every two hours of driving.

The unit may be portable or be connected to the engine management system. At the point of purchase/issue each unit has securely encoded in its' memory the registration number of the vehicle for which it was purchased and on which it will be used. This ties the portable units' records to a specific vehicle thus validating only that vehicles performance. A driver cannot claim that the records are of vehicle X when the unit was actually used in vehicle Y. Nor can he/she use a unit which is not encoded with a vehicle registration number to claim that he/she was at a different place at the time an infraction was recorded against his/her own vehicle.

Method of Operation

At the start of a journey the unit is automatically turned on by the accelerometer and it logs the date, time and place of departure.

The system program provides convenient and fool proof automated intelligent speed adaptation for any and all vehicles. In portable mode as the vehicle approaches each new speed zone the unit only beeps to warn the driver to take appropriate action.

If the unit is connected to the engine management system, the automatic GPS based cruise control of form one is activated, and the unit uses its’ intelligent speed adaptation and geographically based speed zone location tables to interact with the engine management system to slow down or speed up the vehicle to stay within appropriate speed limits in each zone.

In both cases regardless of the drivers actions, wether speeding up or slowing down, the unit automatically records the date, time, location and current actual speed of the vehicle only in case of speeding violations within each speed zone. Pushing the display button displays all recorded violations and a blank display proves no violations occurred.

This record proves beyond doubt what speed the vehicle was doing at a specific date, time and place and disproves any false charges of speeding.

This is important protection for any driver since universal experience has proven the consistent inaccuracy of radar and speed cameras used to incorrectly book motorists who claim the radar and cameras are just a revenue rasing exercise which does not help traffic issues.

Further the program warns the driver to take a suggested 10 minute safety break after every two hours of driving.

System benefits are clear to users, law enforcement and public alike.

### FORM THREE OF THE INVENTION

In form three of the invention the in vehicle monitoring unit consists of 11 components namely a custom designed micro computer, a GPS receiver module, a SATELITE/GPRS/GSM/BLUETOOTH module, a display, a USB connector or smart card reader for data download, an accelerometer, a beeper, an engine management system connector, a power connector, a battery/power source and a solar/thermoelectric battery charger integrated into a thin film and incorporated into the vehicle registration label to be stuck on the inside of the windscreen. This form of the invention is intended for jurisdictions which wish to introduce intelligent speed adaptation and mandate automatic speed monitoring and enforcement to reduce the need for manual policing and speed camera devices. The SATELITE/GPRS/GSM/BLUETOOTH module included in form three allow for automatic speed violation notification to be sent to authorities for fine issuing.

The monitoring unit is supplied with the upgradeable software program of form one of this invention which controls every function of the unit, correlates each vehicle and driver related operational parameter and records the results in its memory. The program also contains a table of the geographical location of every speed zone change as per the 40Km/ph, 45Km/h, 50Km/h, 55Km/h, 60Km/h, etc. road speed signs throughout the country and provides intelligent speed adaptation. Further the program warns the driver to take a suggested 10 minute safety break after every two hours of driving.

Since each unit is an integral part of the vehicle registration label it has securely encoded in its' memory the registration number of the vehicle for which it was purchased and on which it will be used. This ties the units' records to a specific vehicle thus validating only that vehicles’ performance. A driver cannot claim that the records are of vehicle X when the unit was actually registered to vehicle Y.

As the GPS records distance travelled, the possibility of vehicle odometer tampering is eliminated and used vehicle purchasers are fully protected.

Method of Operation

The unit is fully automated and requires no driver input to operate. At the start of a journey the unit is automatically turned on by the accelerometer and it logs the date, time and place of departure. The system program provides convenient and fool proof automated intelligent speed adaptation for any and all vehicles. In unconnected mode, as the vehicle approaches each new speed zone, the unit only beeps to warn the driver.

If the unit is connected to the engine management system, the automatic GPS based cruise control of form one is activated, and the unit uses its intelligent speed adaptation and geographically based speed zone location tables to interact with the engine management system to slow down or speed up the vehicle to stay within appropriate speed limits in each zone.

The driver can always override the system by using the break, or the accelerator to the set absolute maximum speed only, but in both cases regardless of the drivers actions, wether speeding up or slowing down, the unit automatically records the date, time, location and current actual speed of the vehicle only in case of speeding violations within each speed zone.

This record proves beyond doubt what speed the vehicle was doing at a specific date, time and place and disproves any false charges of speeding.

This is important protection for any driver since universal experience has proven the consistent inaccuracy of radar and speed cameras used to incorrectly book motorists who claim the radar and cameras are just a revenue rasing exercise which does not help traffic issues.

Checking and enforcement is carried out automatically by the unit reporting each violation via the SATELITE/GPRS/GSM directly to a central facility or via the BLUETOOTH at petrol stations or other convenient locations equipped with BLUETOOTH receivers relaying the data to a central facility, depending on which method is adopted.

In either case fine notifications can be mailed.

### FORM FOUR OF THE INVENTION

Form four of the invention is used as a trailer/yard monitoring unit, and consists of 8 components namely, a custom designed micro computer, a GPS receiver module, a SATELITE/GPRS/GSM/BLUETOOTH module, a USB connector, a battery, .an accelerometer, a power connector and a solar/thermoelectric battery charger integrated into a small, single, sealed unit.

This form of the invention is used to monitor the trailer while coupled to a prime mover in transit and also to monitor and locate the trailer in the dispatch yard to facilitate logistics, equipment use and scheduling.

The trailer/yard monitoring unit is supplied with the upgradeable software program of form one: of this invention which, controls every function of the unit, correlates each trailer/yard related operational parameter and records the results in its' memory.

In the drawings:

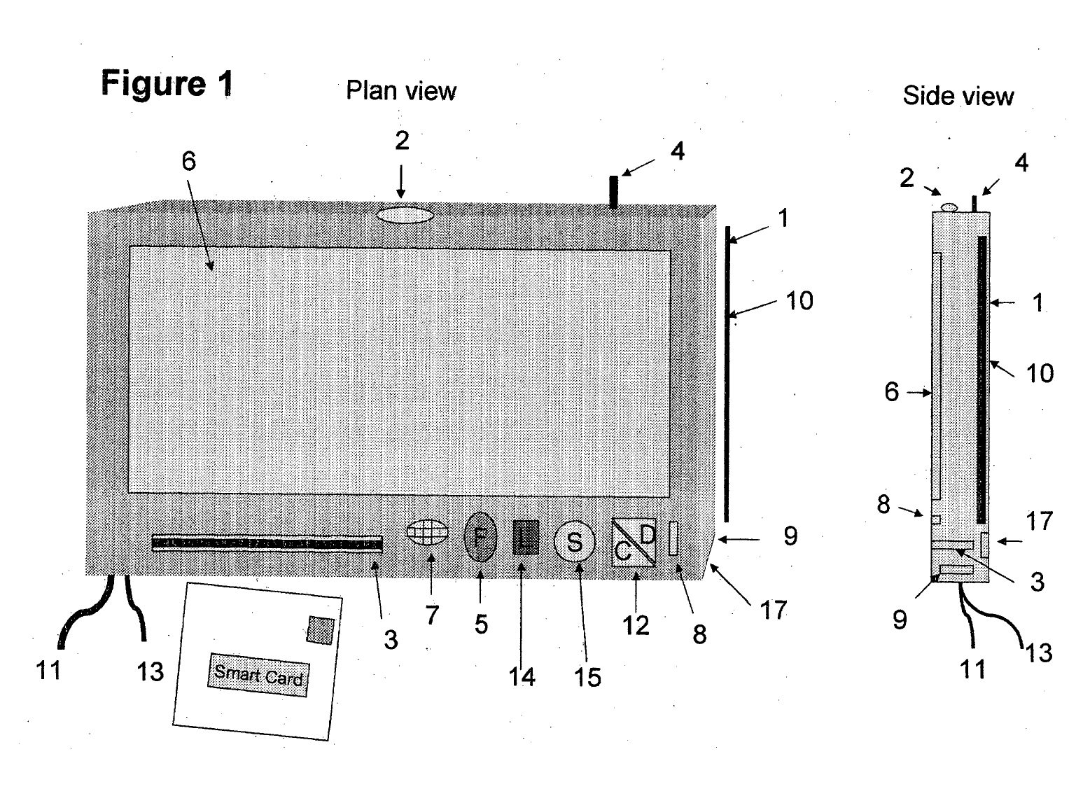

FIG. 1 shows form one of the invention where 1 is the microcomputer 2 is the GPS module 3 is the smart card reader writer 4 is the SATELITE/GPRS/GSM/BLUETOOTH module 5 is the fingerprint module 6 is the display 7 is the beeper 8 is the USB connector 9 is the backup battery pack 10 is the accelerometer 11 is the power connector 12 is the communications button 13.is the engine management system connector 14 is the load/unload record button 15. is the drivers' rest record button and 17 is the battery charger.

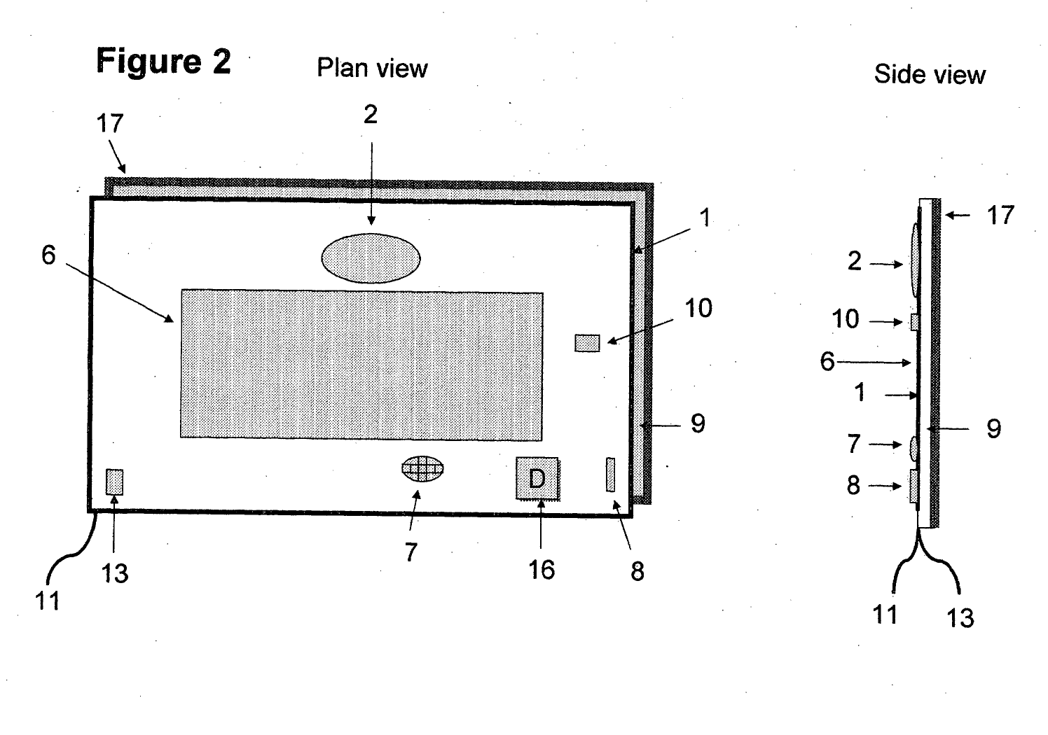

FIG. 2 shows form two of the invention where 1 is the microcomputer 2 is the GPS module 6 is the display 7 is the beeper 8 is the USB connector 9 is the backup battery pack 10 is the accelerometer and 11 is the power connector 13 is the engine management connector 16 is the display button and 17 is the battery charger.

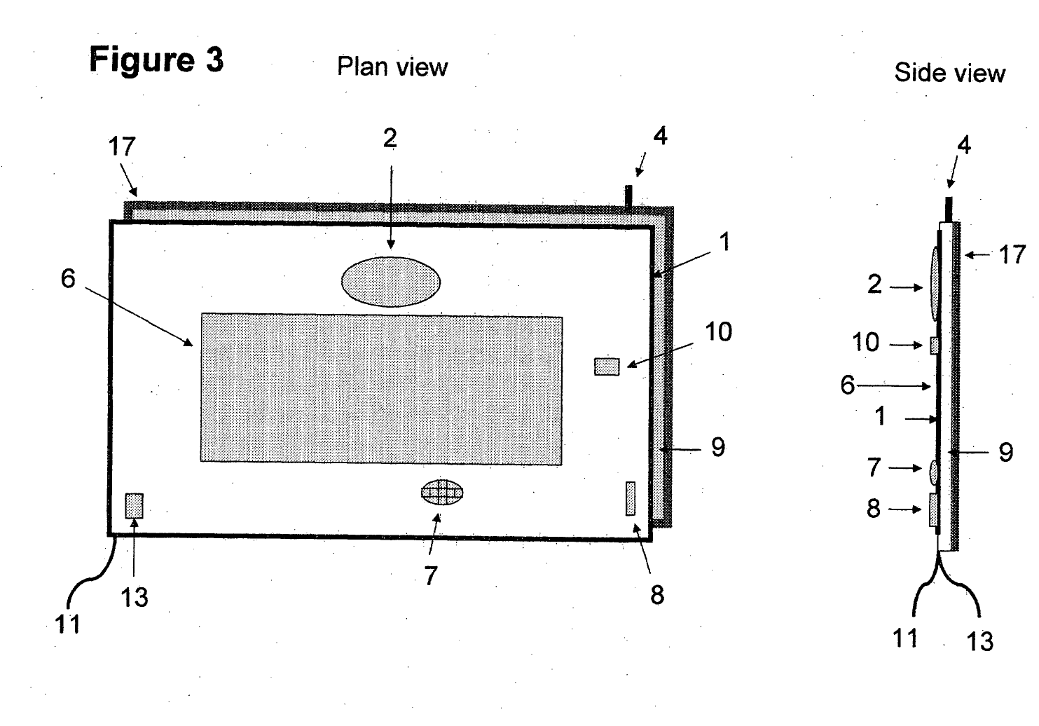

FIG. 3 shows form three of the invention where 1 is the microcomputer 2 is the GPS 4 is the SATELITE/GPRS/GSM/BLUETOOTH module 6 is the display 7 is the beeper 8 is the USB connector 9 is the back up battery pack 10 is the accelerometer 11 is the power connector 13 is the engine management connector and 17 is. the battery charger.

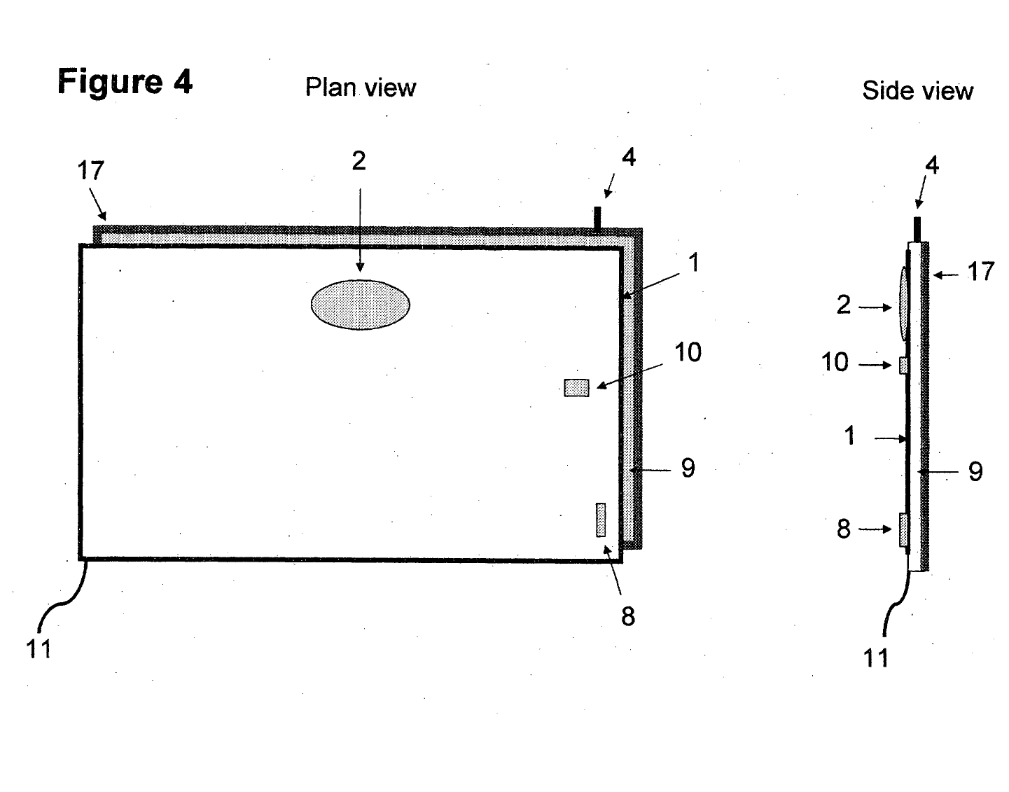

FIG. 4 shows form four of the invention where 1 is the microcomputer 2 is the GPS module 4 is the SATELITE/GPRSIGSM/BLUETOOTH module 8 is the USB connector 9 is the battery 10 is the accelerometer 11 is the power connector and 17 is the. battery charger.

1-47. (canceled)

48: A method and system for carrier, driver, vehicle and cargo monitoring and management by an in-vehicle monitoring unit comprising:
a GPS system;
a GPS cruise control;
a biometrically enabled smart card; and
an intelligent speed adaptation;
wherein said in-vehicle monitoring unit in communications with a national Transport Management Command Centre using a multi-faceted Satellite/GPRS/GSM/Short Range/Bluetooth enabled wireless communications link facility;
wherein said national Transport Management Command Centre monitors every registered vehicle regardless of its carrier/owner/operator status to provide a real time national transport security management and response platform.

49: The method and system of claim 48, wherein said national Transport Management Command Centre comprises: a computer network supporting an internet on-line facility for carrier dispatchers to create, file, store and track route plans, vehicles, drivers and cargo details; a database of all filed and stored on-road route plans, and vehicle, driver and cargo details; all driver hours of service records; detours; road closures; accident sites; adverse weather areas; a national map database containing a geographical speed zone locations table of every speed zone as displayed by road speed signs throughout the country; a table of state border crossings and a multi-faceted Satellite/GPRS/GSM/Short Range/Bluetooth enabled wireless communications link facility.

50: The method and system of claim 48, wherein said national Transport Management Command Centre communicates with the carrier, driver and the in-vehicle unit using said Satellite/GPRS/GSM/Short Range/Bluetooth enabled wireless communications link facility and said internet on-line facility.

51: The method and system of claim 49, wherein every carrier may utilize said internet on-line carrier dispatcher facility and database of claim 49 to create, file, store and track route plans and vehicle, driver and cargo details for its fleet operations.

52: The method and system of claim 48, wherein every carrier may create route plans, vehicle, driver and cargo details on its own in-house system and download said route plans, vehicle, driver and cargo details to said national Transport Management Command Centre using said internet online facility and said Satellite/GPRS/GSM/Short Range/Bluetooth enabled wireless communications link facility.

53: The method and system of claim 49, wherein said filed on-road route plans, vehicle, driver and cargo details, detours, road closures, accident sites, adverse weather areas, the table of state border crossings and geographical speed zone locations table of claim 49 are downloaded to said in-vehicle monitoring unit using said Satellite/GPRS/GSM/Short Range/Bluetooth enabled wireless communications link facility.

54: The method and system of claim 49, wherein said filed route plans, vehicle, driver and cargo details, the table of state border crossings, detours, road closures, accident sites, adverse weather areas and the geographical speed zone locations table of claim 49 are downloaded to said secure biometric enabled smart cards using said internet on-line facility and said Satellite/GPRS/GSM/Short Range/ Bluetooth enabled wireless communications facility.

55: The method and system of claim 48, wherein said national Transport Management Command Centre receives, confirms, alters, maintains, updates, monitors and stores all said filed route plans and driver and cargo details in real time.

56: The method and system of claim 48, wherein said national Transport Management Command Centre receives a signal from said in-vehicle monitoring unit at preset time intervals confirming vehicle and driver adherence to said filed route plans and driver and cargo details.

57: The method and system of claim 48, wherein said national Transport Management Command Centre sends a “reply” request to said in-vehicle monitoring unit whenever said periodic signal from said in-vehicle monitoring unit is not received within the said designated period.

58: The method and system of claim 48, wherein said national Transport Management Command Centre receives an alarm signal from said in- vehicle monitoring unit whenever the vehicle is in violation of said filed route plans, vehicle, driver or cargo details.

59: The method and system of claim 48, wherein said national Transport Management Command Centre intervenes, takes control of and manages the vehicle in case of violation of, or deviation from, said filed route plans, vehicle, driver or cargo details.

60: The method and system of claim 48, wherein said national Transport Management Command Centre sends a “disable” command to said in-vehicle monitoring unit to disable the vehicle in case of emergency or a hostile driver. Further, during police pursuits, a Short Range/Bluetooth communications enabled hand held unit with a limited effective range is used to disable the vehicle.

61: The method and system of claim 48, wherein said national Transport Management Command Centre receives automated accident reports from said in-vehicle monitoring unit and notifies appropriate emergency services.

62: The method and system of claim 48, wherein said national Transport Management Command Centre maintains all driver hours of service records for every licensed driver in the country.

63: The method and system of claim 48, wherein said national Transport Management Command Centre maintenance of all driver hours of service records for every licensed driver in the country eliminates the legal requirement and associated costs to collect and retain driver hours of service supporting documents.

64: The method and system of claim 48, wherein said in-vehicle monitoring unit comprising: a micro computer; a graphical display; an audio interface; a keyboard interface; a touch screen interface; a GPS system; a smart card reader/writer; a fingerprint reader; a USB connector; an accelerometer; a power connector; a battery; a battery charger; an engine management computer interface; a cargo monitoring module interface and a multi-faceted Satellite/GPRS/GSM/Short Range/Bluetooth enabled wireless communications link facility is installed on said vehicle.

65: The method and system of claim 48, wherein said in-vehicle monitoring unit is turned on at installation and remains on indefinitely regardless whether the engine is operating or not.

66: The method and system of claim 48, wherein said in-vehicle monitoring unit enters into ‘sleep mode’ whenever said vehicle is stationary with the engine turned off.

67: The method and system of claim 64, wherein said in-vehicle monitoring unit instantly enters into “wake mode” whenever said accelerometer of claim 64 senses any vehicle movement.

68: The method and system of claim 48, wherein disconnecting the said in-vehicle monitoring unit from the vehicle engine management computer automatically disables the vehicle and logs this event in both the said in-vehicle monitoring unit and said smart card memory.

69: The method and system of claim 48, wherein all vehicle related details including ownership, registration, classification, license and insurance status are encoded in said in-vehicle monitoring unit memory on installation.

70: The method and system of claim 48, wherein the said in-vehicle monitoring unit is programmed for bidirectional communication with said vehicle engine management computer.

71: The method and system of claim 48, wherein the said in-vehicle monitoring unit is configured to execute an upgradeable operating system having a graphical user interface to display multiple windows.

72: The method and system of claim 48, wherein said in-vehicle monitoring unit is configured with an upgradeable operating system which executes all functions of the said in-vehicle unit.

73: The method and system of claim 48, wherein said secure biometrically enabled smart cards are used to record, maintain and transfer drivers’ hours of service records between vehicles

74: The method and system of claim 64, wherein the vehicle engine is enabled and the driver is logged in by inserting said secure biometric enabled, valid driver smart card containing the driver's fingerprints into said in-vehicle monitoring unit and presenting a valid fingerprint to said fingerprint reader of claim 64, and wherein further removing said valid driver smart card from said in-vehicle monitoring unit disables the vehicle engine and logs the driver out.

75: The method and system of claim 74, wherein the driver log in of claim 74 automatically downloads the current data from said biometrically enabled smart card to said in-vehicle monitoring unit.

76: The method and system of claim 75, wherein said in-vehicle monitoring unit displays the data of claim 75.

77: The method and system of claim 48 wherein said in-vehicle monitoring unit further displays the driver hours of service records for the last 8 days wherein every duty status is represented by a different colored horizontal progress bar on a 24 hour log sheet graph.

78: The method and system of claim 48, wherein said in-vehicle monitoring unit displays a “crumb trail” of the filed route plan showing key way points, all state border crossings and all relevant points of driver duty status changes.

79: The method and system of claim 48, wherein said in-vehicle monitoring unit displays all driver duty status violations showing duration of the violations with a horizontal red progress bar representing the duty status being violated.

80: The method and system of claim 48, wherein said in-vehicle monitoring unit displays the scheduled end of every driver duty status with a vertical bar, and further a numerical hour and minute display shows the time remaining in every driver duty status.

81: The method and system of claim 48, wherein said in-vehicle monitoring unit continuously monitors, calculates, updates, records and graphically displays all daily driver log information required to comply with the regulation that logs be updated at regular 15 minute intervals.

82: The method and system of claim 48, wherein said in-vehicle monitoring unit displays the time duration an offending driver must be placed out of service before he is allowed to resume work.

83: The method and system of claim 48, wherein said in-vehicle monitoring unit displays local time zones for the filed route plan as a half tone overlay over the filed route the vehicle will travel.

84: The method and system of claim 48, wherein said in-vehicle monitoring unit is configured with a voice control capability.

85: The method and system of claim 48, wherein the said in-vehicle monitoring unit records all loading/unloading, fuelling, maintenance and wash times by driver input via the audio, keyboard or touch screen interface.

86: The method and system of claim 48, wherein said in-vehicle monitoring unit uses its GPS system and an accelerometer to determine the location and duration of the vehicle's stationary position to record all loading/unloading, fuelling, maintenance and wash times whenever the driver fails to do so.

87: The method and system of claim 48, wherein said GPS system of said in-vehicle monitoring unit continuously monitors the route adherence, position and location of the vehicle in real time, and further the system notifies said national Transport Management Command Centre whenever the vehicle diverts from said filed route plan.

88: The method and system of claim 48, wherein said in-vehicle monitoring unit continuously compares the current GPS vehicle position with said table of geographical speed zone locations to determine what speed zone the vehicle is traveling in.

89: The method and system of claim 48, wherein said in-vehicle monitoring unit always knows what speed zone it is traveling in and using said GPS based cruise control continuously adjusts the engine management computer to automatically maintain the appropriate vehicle speed limit within each speed zone without driver input to provide intelligent speed adaptation.

90: The method and system of claim 48, wherein said in-vehicle monitoring unit audibly and visually notifies the driver of impending speed zone changes and in progress speeding violations within each speed zone.

91: The method and system of claim 48, wherein said intelligent speed adaptation provided by said GPS based cruise control is always active while the engine is running.

92: The method and system of claim 48, wherein applying the brakes disengages said GPS based cruise control allowing the vehicle to slow or stop normally, and further applying the accelerator disengages the GPS based cruise control and allows the vehicle to speed up but only until it reaches an absolute maximum speed limit preset on the said in-vehicle monitoring unit.

93: The method and system of claim 48, wherein said in-vehicle monitoring unit automatically records and displays the date, time, location and actual speed of the vehicle in case of speeding violations within each speed zone.

94: The method and system of claim 48, wherein said in-vehicle monitoring unit automatically reports speeding violations to said national Transport Management Command Centre via said Satellite/GPRS/GSM/Short Range/Bluetooth communications link facility.

95: The method and system of claim 48, wherein said national Transport Management Command Centre processes said automatically reported speeding violations and sends out fine payment notices for enforcement.

96: The method and system of claim 48, wherein said in-vehicle monitoring unit audibly and visually notifies the driver of impending mandated rest breaks.

97: The method and system of claim 49, wherein the said in-vehicle monitoring unit continuously monitors cargo status via the cargo monitoring module interface of claim 49.

98: The method and system of claim 48, wherein said in-vehicle monitoring unit continuously monitors and records the vehicle operating parameters via said engine management computer interface and makes these records available to the national Transport Management Command Centre.

99: The method and system of claim 48, wherein said in-vehicle monitoring unit records and reports all state border crossing with associated GPS coordinates, date and time.

100: The method and system of claim 64, wherein said GPS system and said accelerometer of claim 64 determine and record the location, and scale of severity of any sudden deceleration, impact or accident, and further said in-vehicle monitoring unit automatically notifies said national Transport Management Command Centre of such incidents and sends the last 2 minutes of the logged engine management computer data without driver involvement.

101: The method and system of claim 48, wherein said in-vehicle monitoring unit downloads all records to the national Transport Management Command Centre daily or on demand.

102: The method and system of claim 48, wherein a second embodiment of the present invention is applied to private vehicles using a smart card driver license to operate the vehicle.

103: The method and system of claim 48, wherein a third embodiment of the present invention is applied to untethered trailers.

104: The method and system of claim 48, wherein every registered vehicle, regardless of carrier/owner/operator status, is monitored by said in-vehicle unit and said national Transport Management Command Centre to provide a national transport security and response platform.
